(19) United States
(12) Patent Application Publication
(10) Pub. No.: US 2019/0315266 A1
(43) Pub. Date: Oct. 17, 2019

(54) GENERATING A HOMOGENEOUS LIGHT DIFFUSION BASED ON THE TOPOGRAPHY AND THE MEASURED LUMINANCE DENSITY

(71) Applicant: Hella GmbH & Co. KGaA, Lippstadt (DE)

(72) Inventors: Boris Kubitza, Möhnesee-Körbecke (DE); Udo Venker, Güterlsoh (DE); Carsten Wilks, Lippstadt (DE)

(21) Appl. No.: 16/349,771

(22) PCT Filed: Nov. 6, 2017
(86) PCT No.: PCT/EP2017/078328

§ 371 Date: May 14, 2019

(30) Foreign Application Priority Data
Nov. 22, 2016 (DE) 10 2016 122 492.8

(51) Int. Cl. B60Q 1/14

(52) U.S. Cl. CPC B60Q 1/143; B60Q 2300/32

(57) ABSTRACT

An illuminating device, a method and a computer program product to control an illuminating device for a vehicle which illuminates the surroundings of a vehicle are provided. The illuminating device has multiple illuminating elements which can emit an independent dimmable or switchable luminous flux at a respective solid angle, and thus each illuminates a respective area of the surroundings with an illuminance. The illuminance is adjusted depending on the distance of the area from the illuminating element or the illuminating device.

### CROSS REFERENCE

This application claims priority to PCT Application No. PCT/EP2017/078328, filed Nov. 6, 2017, which itself claims priority to German Patent Application 10 2016 122492.8, filed Nov. 22, 2016, the entirety of both of which are hereby incorporated by reference.

### FIELD OF THE INVENTION

The invention involves a method, a device and a computer program product to control an illuminating device for a vehicle in which the illuminance is adjusted depending on the distance between a point onto which light is emitted and the illuminating device.

### BACKGROUND

The lighting properties in lighting systems currently on the market are determined by optical elements such as lenses, reflectors and the light source itself first and foremost. It is not always possible to adjust the light diffusion (low beams, high beams) during vehicle operation. Headlight technology is currently trending more and more toward high-resolution headlights, which in theory can be used to generate any light diffusion desired. The advantage of such systems is in the high flexibility of the light generation that is achieved through a relatively high horizontal and vertical resolution of pixels that can be individually controlled. The highly localized resolution can be used to further optimize existing light functions, such as “anti-glare high beams”, or to allow new light functions.

The anti-glare high beam light function, with a vertical cut-off line (vCOL), is known. Here, the light diffusion is adjusted to objects that are not allowed to cause glare. Vehicles driving ahead of the illuminating device and/or oncoming vehicles are kept out of the high beam diffusion. In the process, an area separated by a vertical line is kept dark over its entire height, and this also includes positions that could be illuminated without causing glare.

Furthermore, any such fixed light diffusion can result in some situations where lighting areas differ in brightness because the reflective properties of the surroundings are often different.

This approach can only be expanded if the headlight cannot partially light or adaptively control multiple areas. This is not possible with the current headlight designs.

### SUMMARY OF THE INVENTION

The invention solves the task of making the illumination more comfortable and safe for the viewer by illuminating all areas, if possible, at the level of brightness desired. An adjustment of the light diffusion to the surrounding topography should also be made possible in order to achieve a homogeneous illumination. In the process, the different reflective properties of the illuminated areas must also be taken into account so that a homogeneously perceived light diffusion is generated.

The standard approach proposed here should generate an adaptive light diffusion in such a way that a homogeneous illumination of the surroundings or the road is achieved from the driver's perspective and, at the same time, the back-glare occurring is reduced.

The term solid angle refers to a portion of an overall space starting from a point of origin and moving out at an angle in a fan-like manner into the space. Here, the legs of a 2D angle are areas that usually describe the surface of a cone or a pyramid. Conventional light that is emitted in an oriented direction usually fills the solid angle and no lines, because conventional light would never be able to be precisely aligned from a point-shaped light source, as for example would be the case with laser light. It can also be described as a 3D solid angle to simplify the spatial aspect.

The luminous flux (in lumens) refers to the power of visible light emitted per second.

The luminous intensity (in candelas) refers to the luminous flux that falls at a specific solid angle.

The illuminance (in lux) refers to the luminous flux that hits an area at a specific solid angle. In other words, the illuminance on an illuminated area indicates which luminous flux (measured in lumen, lm) falls onto which surface area (measured in square meters, m²). This also refers to the target light value, which indicates how much light should arrive at a specific area.

The luminous density (in cd/m²) refers to the luminous flux that is emitted from an area or returned/reflected. This also refers to the actual light value that is visible from the vehicle; in other words, the brightness or intensity with which the reflected light is perceived by the driver or by a sensor in the vehicle.

An area refers to the projection area; in other words, the part of a surface on which the luminous flux hits and is reflected or absorbed.

This process illuminates this area with the light; in other words, it is lit through reflection. The reflected light is at least partially returned to a potential viewer. The proportion of the returned light is described through the degree of reflection or absorption.

The light diffusion refers to the spatial distribution of the light and the luminous intensity. The overall light diffusion refers to the spatial distribution of the entire illuminating device, while the light diffusion can be based on areas or individual illuminating elements.

The surroundings refers to the area ahead that can potentially be illuminated by the illuminating device. It is also referred to as the scene or scenery. This is the direction in which a vehicle usually travels.

An illuminating device is capable of lighting an area of the surroundings or to send one or more luminous fluxes in the direction of the surroundings. It usually is made up of one or more headlights, particularly the front headlights on a vehicle, which are used to illuminate the surroundings. The purpose of the illumination is usually to ensure that the driver or a camera receives an optical view or an impression of the surroundings.

An illuminating device can also just consist of a portion of an illuminating system, such as an individual headlight module, or even just a single group/array/segment of illuminating elements within a headlight or a headlight module. Here, a headlight module is usually a structural unit, and has at least one illuminating element.

An illuminating element is a device that can emit light in a luminous flux and which forms what is referred to as a pixel. Various illuminating elements or arrays/modules/segments of illuminating elements can usually be controlled independently of one another in terms of luminous intensity. This controllability can include simply turning them on and off. In a more complex version, controlling the brightness or the luminous flux in stages or without stages (dimmable) is also possible.

The effective area of the illuminating device is subdivided into many small areas (pixels) by the illuminating elements. In the process, a light diffusion is generated within the effective area by targeted control of the individual pixels which can be adjusted accordingly. Preferably, there is a uniform subdivision into rows and columns. It is however also possible that the subdivisions can have different shapes and sizes, and can have an irregular arrangement as a result.

High-resolution means that the light diffusion generated by the illuminating device is subdivided into multiple areas (e.g. pixels or pixel arrays), which can be controlled independently of one another. In the process, the number of pixels can be more than 100 or 1,000 or 10,000 or 100,000, for example. With this type of illuminating device, new light functions can be created or existing lighting functions can be adjusted or optimized.

An illuminating element can consist of a single independently-controllable light source with an emitted luminous flux. This is, for example, the case with LED modules.

Alternatively, this could also mean a device that converts light from a light source that is fed by multiple illuminating elements into a single independently-controllable luminous flux without influencing the light source itself. This is, for example, the case with modules that are based on LCD, DMD or LDP.

An LCD illuminating device has one or more light sources with an LC display or an LCD panel in the beam path. The LCD can have a resolution in rows and columns, and is ideally high-resolution.

As a result, the area that can be illuminated by the illuminating device has the same resolution as the LCD. The desired light diffusion is generated by turning the individual LCD pixels on and off.

The light source for the LED illuminating device has an LED matrix and an LED pixel array; in other words, the light source consists of many single LEDs that can be controlled individually, usually arranged in rows and columns. The desired light diffusion can be adjusted through the different brightness levels of the individual LEDs, which are usually dimmable in stages or continuously.

In a DMD illuminating device (based on digital micromirror devices) or a DLP illuminating device (digital light processing), the beam of light is disassembled into pixels by arranging moving micromirrors and then reflecting pixel-by-pixel either into the projection path or out of the projection path.

This invention particularly solves this issue by using a method to control an illuminating device for a vehicle that illuminates the vehicle's surroundings. The illuminating device has multiple illuminating elements which can each emit an independently dimmable or switchable luminous flux at a respective solid angle, and thus each illuminates a respective area in the surroundings with an illuminance. The illuminance is adjusted depending on the distance of the area from the illuminating element or the illuminating device.

This invention furthermore specifically solves this issue by using an illuminating device for a vehicle that illuminates the vehicle's surroundings.

The illuminating device has multiple illuminating elements which can each emit an independently dimmable or switchable luminous flux at a respective solid angle, and thus each illuminates a respective area in the surroundings with an illuminance. The illuminance can be adjusted depending on the distance of the area from the illuminating element or the illuminating device.

In addition, this invention also features a computer program product to control an illuminating device for a vehicle. The computer program product is intended to be designed in such a way that it can run a method in accordance with this invention. In particular, an illuminating device in accordance with the invention can be used in the process.

Additional advantages of the invention are the result of the additional subclaims.

The illuminance is determined using the distance. Because the light from the illuminating element propagates in the solid angle (e.g. conical or pyramid-shaped), the illumination of each surface area (e.g. 1 cm²) is based on distance.

If, for example, you would like a homogeneous or evenly bright illumination of closer and more distant areas, then the luminous flux to more distant areas obviously needs to be greater or stronger for the same sized surface. In other words, the same luminous flux results in a lower luminous density at greater distances from the area (projection area) and at the same solid angle; in other words, less light arrives at an area of a particular size compared to an area of the same size at a smaller distance.

To achieve a specific illuminance (luminous density) that is independent of the distance, or perhaps better stated, is the same for all distances, the luminous density can increase quadratically with the distance according to the laws of physics. Additional influences, such as optical damping through, for example, weather influences, etc., are exceptions from this.

The illuminance results from the strength of the luminous flux emitted and from the performance (light performance) of the illuminating element. The actual control factor is technically usually an electrical factor (e.g. voltage, actuator current), depending on the headlight technology used.

The most physically precise of the various distances and/or spaces is that between the area and the illuminating element, because this is the precise point of origin for the solid angle. Since the illuminating elements are usually close to one another, the distance of the area to the illuminating device can also usually be selected since it is a good approximation, particularly at great distances. Likewise, the vehicle could also be selected as the reference point instead of the illuminating element or device.

Usually, different illuminating elements illuminate different solid angles. However, this does not always have to be the case, for example if the illuminating elements arranged next to one another emit their luminous flux in parallel; this would mean the cones that form the solid angle overlap as of a specific distance. It can also be the case that different headlight modules (e.g. for low beams and high beams) emit into the same solid angle. This analysis is an approximation, because the modules usually cannot be positioned at the same place and, therefore, the point of origin of the solid angles would be the same.

Advantageously, the target light values (illuminance) can be determined for every solid angle during travel, based on distance.

Instead of the area and the luminous density, which is of course based on two-dimensional expansion of the cross-section of the beam of light, a simplified modeling can also be used. This means that the method can also be used for point-shaped illumination. To do so, points would be used instead of areas and a luminosity would be used instead of the luminous density, especially for point-shaped light sources or reflex points. This point-shaped approach can also be used for idealized modeling of real illuminating devices and areas.

According to one embodiment of the invention, in the method, this setting is made for most or for all of the illuminating elements of the illuminating device.

This means that every solid angle that belongs to most or all of these illuminating elements is also illuminated. In the process, the settings are not made at selected points; instead, they are made in larger areas that are comprised of many of these areas put together at which the solid angles hit when they are projected.

This also means that all of the areas that the illuminating elements can project onto can be adjusted in their illuminance, regardless of the type of surroundings or topography ahead, to create the luminous density desired.

In other words, the calculation of the target light value (illuminance) for, say, a homogeneous light diffusion is determined for every solid angle and/or 3D solid angle based on distance. Advantageously, this makes a complete illumination of the surroundings with high-beam-like light diffusion possible. Furthermore, advantageously, generating a light diffusion that is homogeneous for the driver which is similar to light diffusion during the day is possible without system-dependent light centers (hot spots).

In a particular design, all illuminating elements of the illuminating device or the headlight are able to be dimmed or switched and controlled in accordance with the invention.

In a particular design, at least one group of most of the illuminating elements can also be selected on which this method is to be applied. This means it is possible to select an area that will be illuminated. This can advantageously take on various forms based on the choice of illuminating elements that emit onto the affected solid angle. In turn, the selection can also be made based on other parameters, such as object detection. This means that objects (such as other vehicles, danger points, course of the road) can be brightened, dimmed or illuminated homogeneously.

According to an embodiment of the invention, the method determines a topography of the surroundings and/or a topography of the course of the road.

The topography of the surroundings is a description of the surface of the earth and the natural and artificial objects that are permanently on it. If applicable, the term 3D topography can also be used to emphasize the height aspect, which includes distances in the direction of the geocenter or perpendicular on the z-axis plane.

The topography of the course of the road describes the position of the points which make up the road. It can be used to derive the course, direction, bends, etc.

The topography includes the position of points of the surface and, with it, also implicitly the distance of the points from one another. If an observer's (or here, the illuminating device) location is known, then advantageously, the distance between the observer and a point can be determined.

According to an embodiment of the invention, the method is designed to determine the topography and/or the distance using a suitable data source or sensors, where the surroundings are read out at various measuring points.

In the process, for example, a map can be used as a passive data source on which 3D topographical data are stored. Advantageously, this means that if the topography of the places where the vehicle will be in the future is already known in advance, then the corresponding light diffusion can also be pre-set and, in this way, the delay until the settings are corrected which would occur when using sensors is avoided.

An (active) sensor can also be used to measure the topography. For example, this can be done optically using a camera or an infrared camera or a laser-based measurement (lidar) or radar. Advantageously here, the actual and the current surroundings, which could have changed compared to what is stored on a map, are taken into account.

In the process, the distance can be determined at specific measuring points, such as based on a grid on the map or on measurements taken by the sensor (e.g. pixel-based).

By measuring at various measuring points, these points read out the surroundings and the parameters of the surroundings at these points, e.g. the distance. There are various known methods according to the state of the art to determine the distance, such as brightness analysis, feature analysis, triangulation, etc.

The measured values of the parameters of the surroundings are then assigned to the correct solid angles. This can be done through a coordination transformation.

If applicable, the distance of the measuring points is also included in this transformation, since the sensor and the illuminating device are usually not in the same position. This means, for example, that a measuring point (pixel) in a camera image is also measured and illuminated at different distances from different solid angles. This means that horizontal and vertical angles can also be determined from the sensor data.

In one design example, to determine the illuminance of a point on the street grid, the distance from a point on the road or in the surroundings to the headlight is calculated using the horizontal and vertical angles.

In a particular design, the solid angle of the illuminating elements are adjusted in such a way that the measuring points are the same as those on the grid. Alternatively, the grid of the measuring points is adjusted or selected in such a way that it matches the solid angles of the illuminating elements.

Advantageously, there is then a simple arrangement that avoids complicated conversions.

According to one embodiment of the invention, an interpolation is made between two of the various measuring points in the method.

If necessary, an interpolation is made between the points of the measured values, and particularly when the grid of the measured values is made in such a way that the solid angles do not cover everything equally or cannot simply be assigned to the measuring grid. An interpolation may also be necessary if the sample, e.g. the number of measuring points, is too low, particularly if it is lower than the number of solid angles. Advantageously, measuring systems that are already available for other purposes or that are easy and cheap to obtain can be adapted and used for this purpose.

In a particular design, the interpolation is linear.

This advantageously includes a simple algorithm for which the measured values of two measuring points is sufficient.

In a particular design, an iterative or recurring or ongoing measurement takes place at the various measuring points while the vehicle is moving. This advantageously allows an adaptive light diffusion which is constantly adjusted during travel to the topography detected.

A homogeneous illumination of the surroundings, e.g. the road, can be realized by measuring the three-dimensional topography of the course of the road ahead or the three-dimensional spatial coordinates in front of the vehicle using a sensor suited to this purpose and a distance-based target light value (illuminance). The calculation of the target light value for the homogeneous light diffusion is thus determined for every solid angle, based on distance.

In one embodiment of the invention, the illuminance is also adjusted based on the luminous density in the method.

The luminous density is determined using the same area where the corresponding solid angle meets the illuminating element and which illuminates this area with its illuminance.

This determination or measurement of the luminous density and surrounding intensity is used to check whether the target light values (illuminance) have been adhered to and/or reached. This is because technically speaking, the calculation of the distance-based, homogeneous illumination can only be used for a specific surface property; in other words, with a steady/constant reflective property in all points. But because objects have different reflecting properties, the target light values (illuminance) can be corrected according to the light intensity (luminous density) emitted.

The reflected light can be measured based on an intensity measurement using a suitable sensor (e.g., camera). Ideally, the same camera that is used to determine the distance can be used for this.

Advantageously, an illumination adapted to the actual conditions can be achieved in this way and the light diffusion can appear as desired.

In one embodiment of the invention, the method also homogeneously adjusts the luminous density for at least one part of the surroundings.

In the process, a homogeneous light diffusion or a constant luminous density should be achieved.

In the process, the luminous flux of the illuminating elements is adjusted in such a way that an illumination of each individual pixel of a desired area occurs in such a way that the reflected light is perceived with a homogeneous/even brightness in the vehicle. Advantageously, this helps the driver and/or the camera, because his or her eyes or its sensors only need to detect a low dynamic range.

In a particular design, the area can also be based on the entire area that can be illuminated (overall light diffusion). Alternatively, just certain areas can be measured, such as the road ahead, while other parts, such as the landscape that is not relevant to traffic, does not have to be included.

If the illuminance adapts quickly enough, then it is possible that the measurement of the distance of the areas from the illuminating elements can even be done away with completely in a further embodiment.

In one embodiment of the invention, the illuminance is reduced if the luminous density is too high in the method.

The areas with luminous density that is too high (greater than the target value) are therefore reduced by means of a control loop. In the process, the actual light value (luminous density) is measured and compared to and evaluated against the target light value (illuminance).

Advantageously, this makes it easy to determine which areas need to be reduced, e.g. those that have been affected by objects such as signs, wet road, bridges, tunnels, guardrails etc. Complicated object detection is therefore no longer absolutely necessary.

This can easily be seen with, say, traffic signs, which can reflect back-glare at the driver. This means that as a consequence, the back-glare in the respective solid angle can be reduced or controlled to the distance-dependent target light value, e.g. the illuminance, depending on the light reflected, i.e. the measured luminous density. This reduces the target light values on highly reflective traffic signs, for example, according to the light reflected.

This method can also be used for other highly reflective surfaces, such as wet roads or self-illuminating objects.

In one embodiment of the invention, the illuminance is increased if the luminous density is too low in the method.

Increasing the light target value (illuminance) is likewise feasible if the calculated target values cannot be reached. Areas with luminous density that is too low (target value too low) are provided with brightened illumination accordingly.

In other words, the target light value is increased if the back measurement shows that the intensity is an actual light value that is too low. The above applies analogously.

Dark areas with poor reflecting properties can therefore also be illuminated homogeneously. Different road surfaces with different reflecting properties (e.g. asphalt, concrete) can therefore be made more visible, and there is less of an impression of a dark background.

Here, it must be noted that in a particular design, the illuminance must be selected in a normal state, e.g. without adaptation by back-measuring the luminous density, such that the luminous flux can still be increased.

The illuminating elements must not already be emitting their maximum light performance. The normal target value should be selected such that it is not the maximum one possible.

### BRIEF DESCRIPTION OF THE DRAWINGS

Reference is now made more particularly to the drawings, which illustrate the best presently known mode of carrying out the invention and wherein similar reference characters indicate the same parts throughout the views.

FIG. 1a is an initial visualization of a course of a road in space.

FIG. 1b is an initial road projection.

FIG. 1c is an initial light diffusion on a projection wall.

FIG. 2a is a second visualization of a course of a road in space.

FIG. 2b is a second road projection.

FIG. 2c is a second light diffusion on a projection wall.

FIG. 3a is a third visualization of a course of a road in space.

FIG. 3b is a third light diffusion on a projection wall.

FIG. 4 is a flow chart of the method.

### DETAILED DESCRIPTION OF THE DRAWINGS

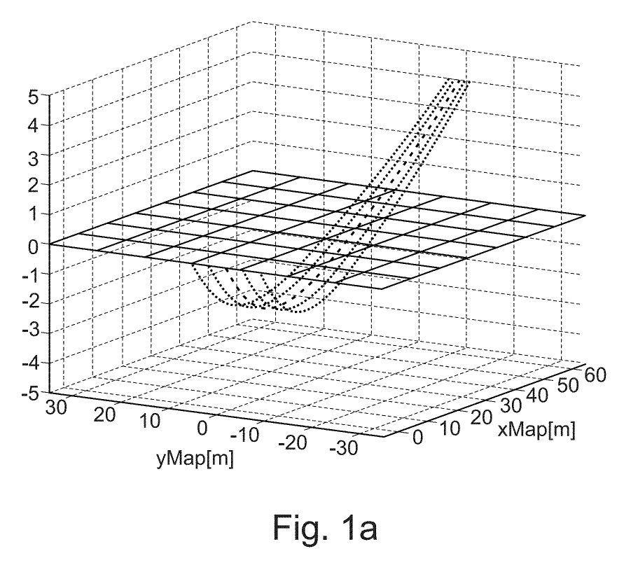

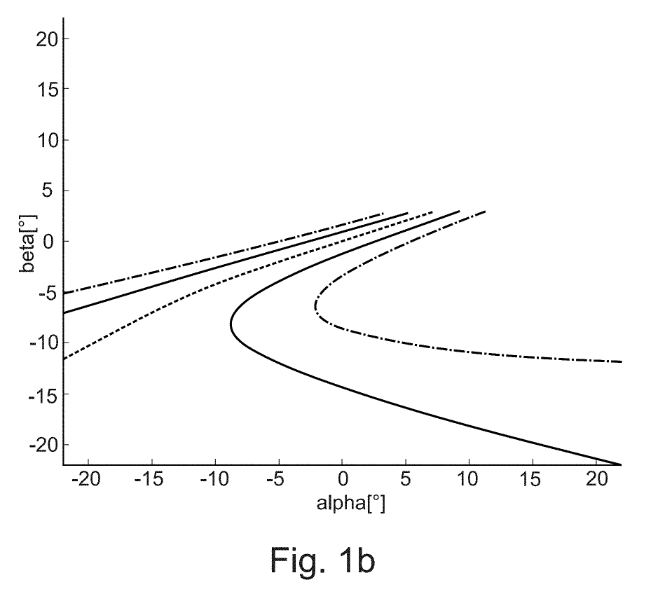

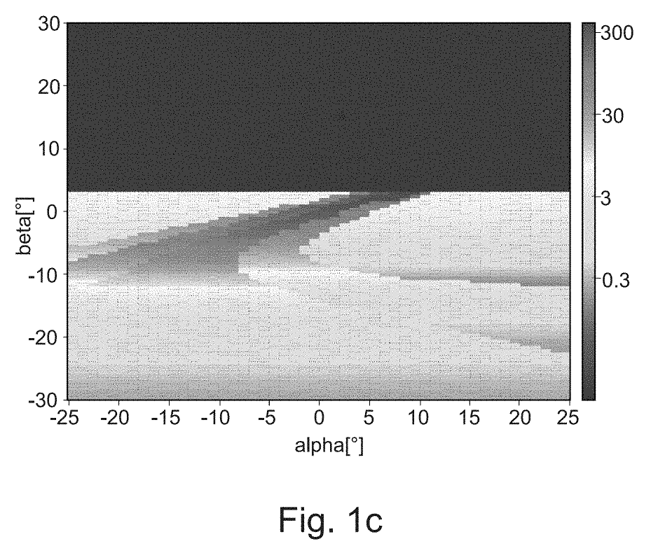

FIG. 1a shows an initial visualization of the course of a road in space using object map visualization. In it, the three Cartesian spatial coordinates are visible; the lattice design on the grid at height 0 is a standard area with the vehicle as a reference point.

The road ahead with the course of the road is shown as a dotted line, pictured here with a curve to the right.

FIG. 1b shows the course of the road according to FIG. 1a applied to a projection area (street projection). The x- and y-axes in the drawing indicate the solid angle (alpha, beta). The lines of the traffic lane indicate the edges of the traffic lane and the lane markings such as the center line and the shoulder line, based on where they are located.

FIG. 1c shows the projection area according to FIG. 1b. Here, the illuminance which correlates to the distance is applied. This means that the locations on the projection wall at which the more distant area of the course of the road can be seen are provided with a stronger illuminance. The end effect is that this causes the real surroundings to be illuminated homogeneously, i.e. at an even level of brightness (luminous density).

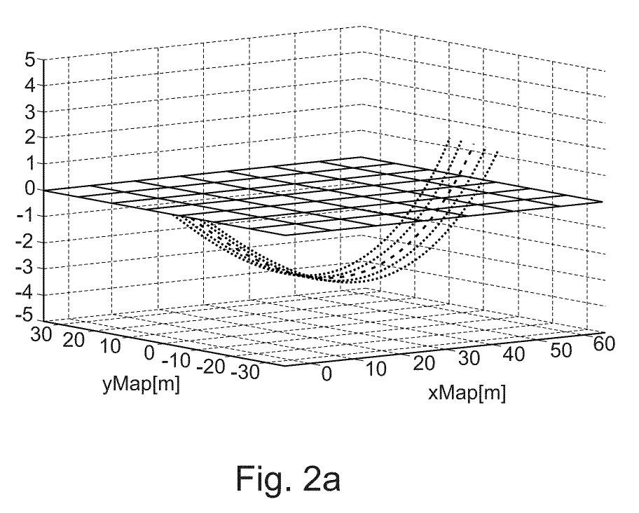

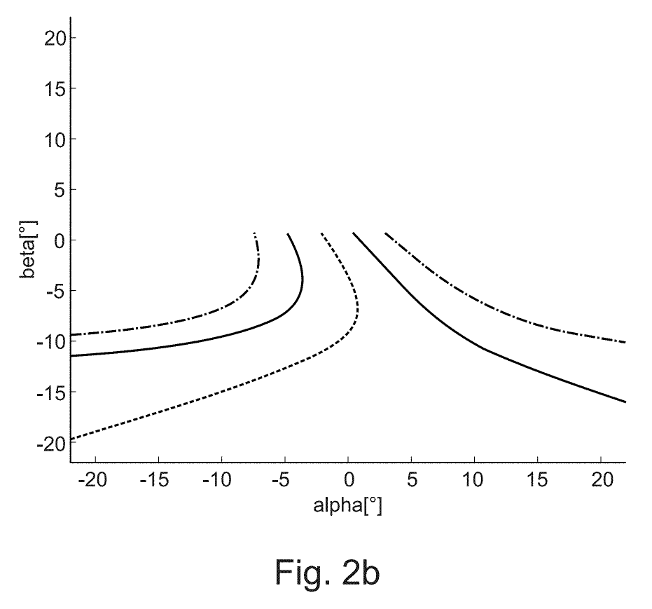

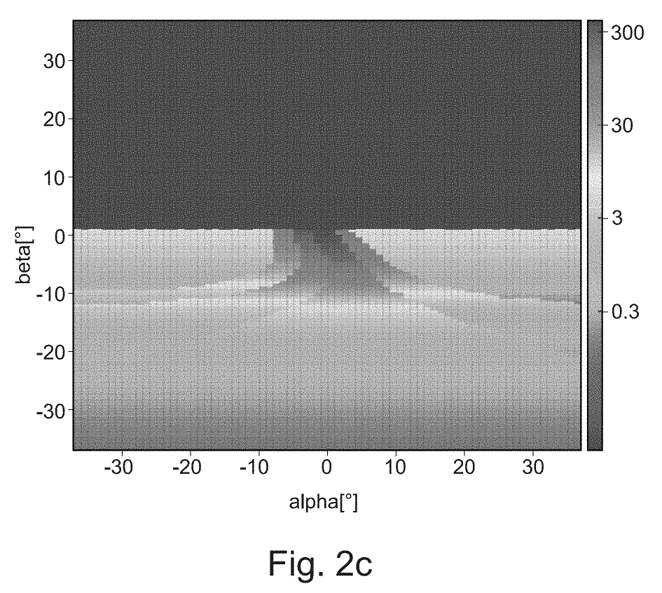

FIGS. 2a, b and c, similarly to FIGS. 1a, b and c, show a course of a road, pictured here with a depression ahead and then an incline.

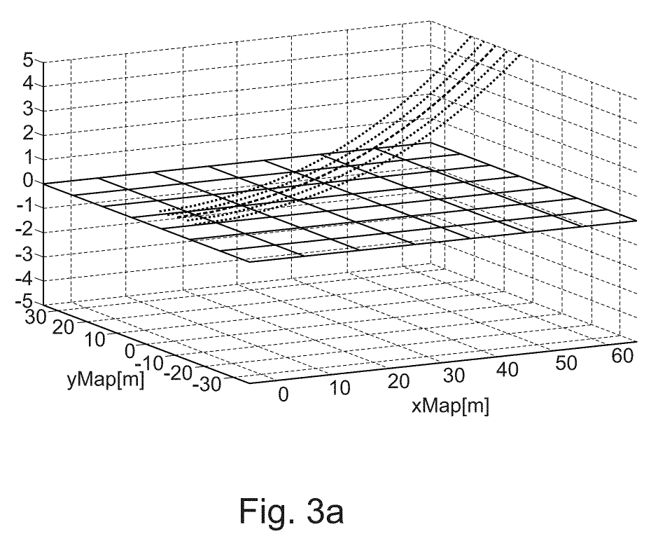

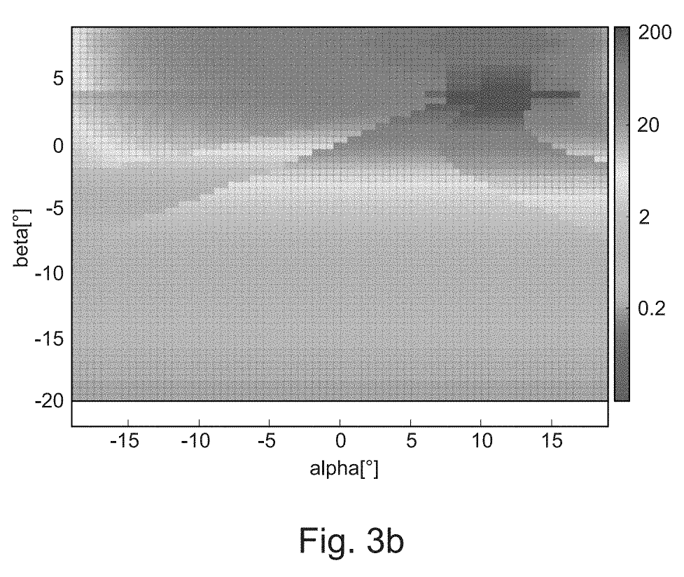

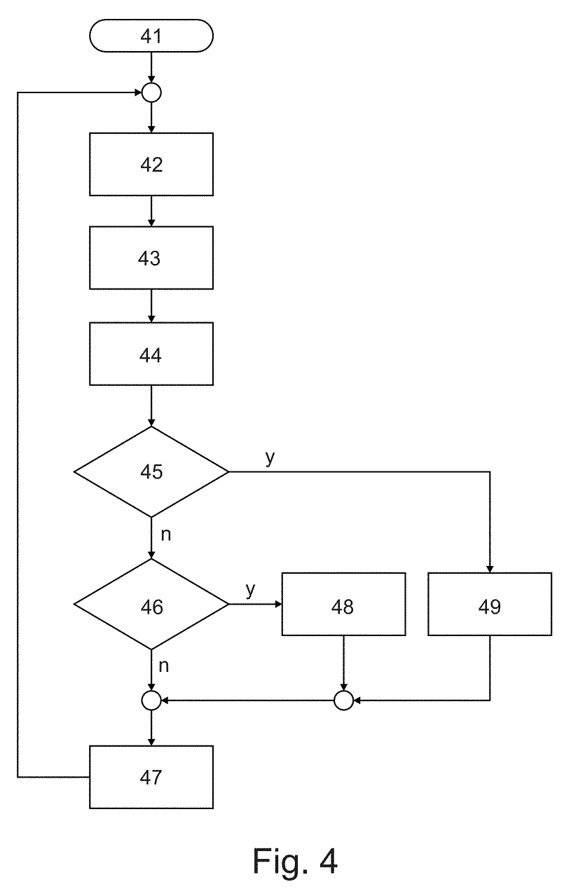

FIGS. 3a, b and c, similarly to FIGS. 1a, b and c, show a course of a road, pictured here with an incline ahead. FIG. 4 shows a flow chart of the method.

Starting at a start point 41, the 3D solid angle and the distances are determined 42, followed by calculating distance-based target light values (illuminance) 43 and then determining the actual intensity of the surroundings (luminous density) 44. If a check of whether the actual intensity is greater than the target light value then comes back positive 45, then the light target value will be reduced 49. If the check comes back negative 45 and another check of whether the actual intensity is smaller than the target light value comes back positive 46, then the light target value will be increased 48. Finally, the new target values will be transmitted to the headlight 47. Then, the sequence can start over again from the beginning.

### REFERENCE NUMERAL LIST

41 Starting point
42 Determination of the 3D solid angle and distances
43 Calculation of the distance-dependent target light values
44 Determination of the actual intensity of the surroundings
45 Check of whether the actual intensity is greater than the target light value
46 Check of whether the actual intensity is smaller than the target light value
47 Transmission of the target values to the headlight
48 Increase of the light target values
49 Reduction of the light target values

1. A method for controlling an illuminating device for a vehicle that illuminates the vehicle's surroundings,
adjusting an illuminance of the illuminating device based on a distance of an area to multiple illuminating elements or the illuminating device, wherein the multiple illuminating elements emit an independent dimmable or switchable luminous flux at a respective solid angle, and thus each illuminates a respective area of the surroundings with the illuminance.

2. The method in accordance with claim 1, wherein the adjustment is performed for most or for all of the illuminating elements of the illuminating device.

3. The method according to claim 1, wherein a topography of the surroundings and/or a topography of the course of the road is determined.

4. The method according to claim 1, wherein the topography and/or the distance is determined via a suitable data source or sensors, where the surroundings are read out at various measuring points.

5. The method in accordance with claim 4, wherein an interpolation is made between two of the different measuring points.

6. The method according to claim 1, wherein the illuminance is also adjusted depending on a luminous density.

7. The method in accordance with claim 6, wherein the luminous density is homogeneously adjusted for at least one part of the surroundings.

8. The method in accordance with claim 6, wherein the illuminance is reduced if the luminous density is too high, and wherein the illuminance is increased if the luminous density is too low.

9. An illuminating device for a vehicle that illuminates the vehicle's surroundings, the illuminating device comprising:
multiple illuminating elements that emit an independent dimmable or switchable luminous flux at a respective solid angle, and thus each illuminates a respective area in the surroundings with an illuminance,
wherein the illuminance is adjusted depending on the distance of the area from the illuminating element or the illuminating device.

10. (canceled)
